(19) United States
(12) Patent Application Publication
(10) Pub. No.: US 2015/0032762 A1
(43) Pub. Date: Jan. 29, 2015

(54) System and Method for Filtering One's Personal Availability, Based on Preferences and Matching

(71) Applicant: Tiberiu Stef-Praun, Elmhurst, IL (US)

(72) Inventor: Tiberiu Stef-Praun, Elmhurst, IL (US)

(21) Appl. No.: 13/952,646

(22) Filed: Jul. 28, 2013

(51) Int. Cl. G06F 17/30

(52) U.S. Cl. CPC G06F 17/30699
USPC 707/754

(57) ABSTRACT

A system and method for defining, recording and making available for search, aggregation, and matching a user's availability, as determined by a filter constructed on the user's own personal preferences and on the matched persons' characteristics.

In particular the system consists of a methods and an apparatus that elicits a) filter parameters based on one's preferences and b) the personal characteristics on which to be matched by other's filters, c) a storage component that records the information collected above, and d) a matching and aggregation component that will match a plurality of users' filters and spatio-temporal presence to unmask their availability.

This system and method allows its users to off-load their characteristics and preferences about matching against other users, and it improves the chance of discovery and interaction with only the ones who fit the desired profile, by having those preferences available for searching in a perpetual fashion, as long as they are recorded in the system embodiment.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

The present invention relates to the field of personal and/or group communication and scheduling, and addresses in particular the indication of availability of a user, based on matching of two or more independently provided sets of characteristics, traits or attribute preferences. The bi- and multilateral independent information provided for matching and filtering ensures truthfulness and optimal identification of the availability for further interactions based on mutual interest.

2Description of the Related Art

Location based services are focusing on notifying the mobile user, when they are in a certain location as determined by a positioning device such as a GPS-enabled mobile phone, about the events and people that can be found in the surrounding area. Further refinements such as U.S. Pat. No. 8,102,253, U.S. Pat. No. 7,911,335, U.S. Pat. No. 7,847,684 allow for the specification of user's preference to select what type of notifications should the users receive, and EP 1648144 A1 and WO2010075870A1 specify what methods to be used to reach the user. Our invention changes the setting of the patents above, by eliminating the presence at the current location as a determining factor, and by introducing the temporal dimension selection factor, that allows the user to specify and filter their future availability opportunities. In effect our invention allows users to manage long term preference and availability, and by the dynamic nature of the matching technology, to only present to the users the most current and valuable connections for them. Our invention thus enables long-term planning and more efficient resources identification and allocation over time.

Policy-specific communication availability methods such as U.S. Pat. No. 6,714,519 seek to automate the communication availability of the subscriber under certain conditions. Our invention changes the setting of this patent by eliminating the unilateral specification of a policy, and introducing a bi- and multilateral matching of a plurality of user's preferences, to determine who can communicate with whom. In our invention, the private and asymmetric nature of users' defined characteristics and preference filters, and the facility to potentially vet the quality of information submitted allows the users of this invention to obtain high quality matches, by the fact that there are two independent set of conditions that need to be satisfied, from two users who have no means of communicating beforehand and thus influencing the outcome of the results. The dual-matching, and the bilateral definition of filtering conditions will result both into higher-quality matches and in a more decoupled way of identifying those matches.

### BRIEF SUMMARY OF THE PRESENT INVENTION

The present invention is an improvement over other means of defining and unmasking a person's availability in that it involves and relies on a double-set matching mechanism that takes into account both the initiating person's preferences and the counterparties' characteristics, and vice-versa, in addition to spatio-temporal coordinates that describe the said availability.

In particular the present invention allows the user to specify the parameters of an instance of their availability opportunities, and the system that implements this invention will continuously match that with the preferences, characteristics, traits or attributes of the new users. When a match occurs, only the users whose preferences and characteristics triggered the availability filters get returned in the resulting set. By being very specific, the users can get very specific matches for who they want to become available for.

In operation, the user will define their own characteristics on which they get matched by other user's searches and matches, and will also define the set of preferences that characterize the users that they are interested in. As the system identifies a match, the information regarding the match becomes available to the user who can engage in direct communication with the matched counterparty.

It is therefore the object of the present invention to provide a new and improved system that identifies bilateral matches of preferences, characteristics, traits or attributes, in space and in the present and future time, with direct application to sharing the user's availabilities to meeting other people.

It is another object of the present invention to provide a new and improved method for defining and exposing a person's availability, through the use of a well-defined set of preference filters that complement potential spatio-temporal coordinates.

Yet another object of the present invention is to search, match, aggregate, and present to its users the set of matching profiles of the users who are a fit for the preferences specified by the initiating user, with the purpose of enabling the initiating user to connect with the people they are most interested in, for further interaction outside the scope of this invention.

### BRIEF DESCRIPTION OF THE DRAWINGS

FIG. 1 is a diagram illustrating the embodiment of the invention, showing the structure and the detail of the user profiles, the storage component, the processing engine, and the availability set resulting from a user's querying the system.

FIG. 2 is a flowchart diagram illustrating the steps that the users go through when they record their characteristics and availability opportunities, consisting of coordinates and preference filters, and also illustrate the subsequent search operations that helps them identify the specific users that have the desired characteristics that match the user's preference filters.

FIG. 3 is one example of one embodiment of a user's personal profile characteristics.

FIG. 4 is one example of one embodiment of a user's preference filters that correspond to the given specific availabilities.

### DETAILED DESCRIPTION OF THE INVENTION

This invention is an improvement over conventional methods of identifying and/or scheduling interactions (meetings, partnerships, etc) with appropriate (mutually desired) partners. The invention introduces a system and method that allows its users to record a set of availability opportunities, specified by coordinates, including but not limited to any combination of location, time, a perpetuity thereof, or even none, and to specify an associated set of preference conditions in the form of availability filters, that will be used to determine those users' availability status. Additionally each user of the system will have an associated set of characteristics that describes their own profile, such as but not limited to social, demographic, economic, educational, etc, characteristics, which will be used by the system as a matching counterparty for the other users' preference filters. When there is a match of a user's characteristics and features to someone elses' preference filter, the user's availability becomes visible, and the matching pair, or more generally matching group, of users will have the opportunity to connect and communicate further using any means they see fit.

In effect the invention provides a method to off-load the user's preferences related to who they are available for and would want to connect with. The invention specifies matching as the method for aligning the user's preferences (or availability filters) and characteristics with those of any other person's' or group's. By having users define, store, and make available their preferences through the system introduced here, the invention allows continuous matching against other users' preferences and characteristics, thus eliminating the requirement of being present at the same time and/or place to execute on a match. The invention also provides a proxy for a point of contact for those who the current user wants to establish contact with. By relying on the system for identifying relevant contacts, the invention makes the search for new contacts perpetual, and allows for an effective, high quality, and automatized filtering according to the user's specifications, thus providing a significant time, communication, and energy savings.

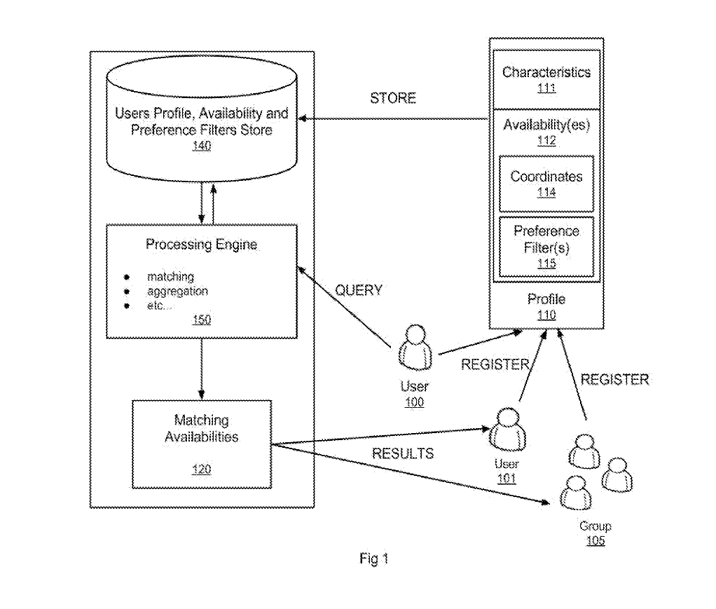

One embodiment of the system, as depicted in FIG. 1 consists of the system that receives the profile 110 from a user 100, and persists this profile together with the other profiles of all the other registered users 101, groups 105 or those of any entities using the system, looking at exposing their availability in a filtered fashion.

The profile 110 associated with a user of the system consists of two major logical components: the set of characteristics 111 that describe the user in the system, and the list of availabilities 112 that describe the availability opportunities at which the user is available and can be contacted, should the preference filters 115 associated with that specific availability produce a match.

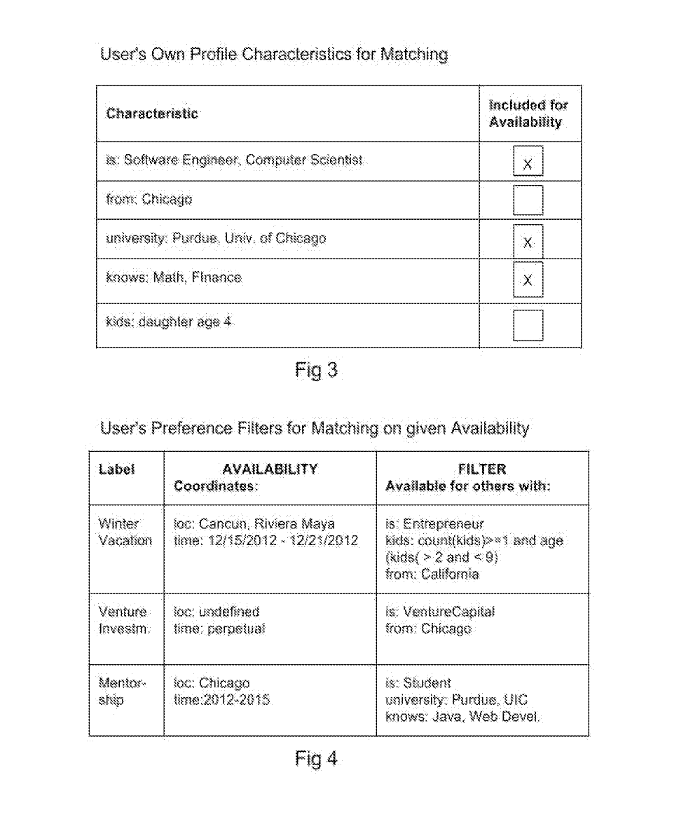

The characteristics 111 describing the user in their own view are depicted in detail in FIG. 3. In one embodiment, the characteristics associated with a user will consist of a set of categories that encompass various features of that user, and for each element in the categories set, the user can specify a list of attributes that describe them according to that category. For instance, one embodiment can have as categories any of but not limited to: “from”, “university”, “kids”, “occupation”, etc. . . . In each of those categories the user might choose to add attributes describing them for the purposes of other users matching against those attributes. Categories with no attributes will not appear in the matching logic.

The availability entries 112 are the main topic of this invention. FIG. 4 details the elements that make up each availability opportunity. The two major elements that make up an availability are the coordinates 114 and the reference filters 115. In one embodiment, the coordinates of the availability may consist of but will not be limited to a spatial coordinate (such as but not limited to a specific location, an approximate, general area location, or even undetermined), and a temporal coordinate (such as as a fixed date, an interval, a perpetual availability, or even none). Each availability opportunity will also have a set of zero or more filters 115 associated with it, such that, in one embodiment, all the filters will have to evaluate to a boolean “true” value, for the availability to become visible for the specific user whose characteristics triggered those filters.

The filters 115 are being matched in the processing engine 150 against the characteristics 111 of the users doing the search for other's availabilities. The filters 115 consists of a plurality of entries similar to the characteristics 111, with a set of categories that are of interest for the current user defining the filter, and a set of attributes in those categories pinpointing specifics that the matching logic will use to identify which user with the appropriate characteristic attributes will trigger the filtering and make visible the availability opportunity. For example, in one embodiment, as seen in FIG. 4, the filters determining the availability for being approached while on vacation in Cancun or Riviera Maya, specify the requirement for the other party to be an Entrepreneur from California, and to have kids with ages between 2 and 9.

All the user's profiles 110, as detailed above, are saved in the storage component 140, and made available for later search and matching by the processing engine 150 component. The system will provide a way to the users to access their stored profiles, and manage their characteristics 111 and most importantly the availabilities 112.

Complementary to the storage component 140 is the processing engine 150, whose role is to execute the searches that identify matching preference filters against other user's characteristics. For this purpose the engine 150 has access to the storage component 140, and given one user's 100 query for an availability opportunity with given parameters—in one embodiment, using the coordinates for the requested availability—it will identify all the registered users 101, 105 whose preference filters were triggered open by the characteristics of the user 100 doing the search. The processing engine 150 relies in one embodiment on boolean logic to do the matching of the characteristics and filters attributes, but the invention does not preclude the matching to be done using other methods such as value functions, thresholds, or any other methodology that compares two or more sets of attributes.

The processing engine produces a set of matching availabilities 120 that includes the users 101, 105 and their specific availabilities that the searching user 100 can act upon. The resulting list can be presented to the user in various forms, with the expectation that the user will employ other means, outside of this invention, to contact and pursue further the availabilities that have become visible for them.

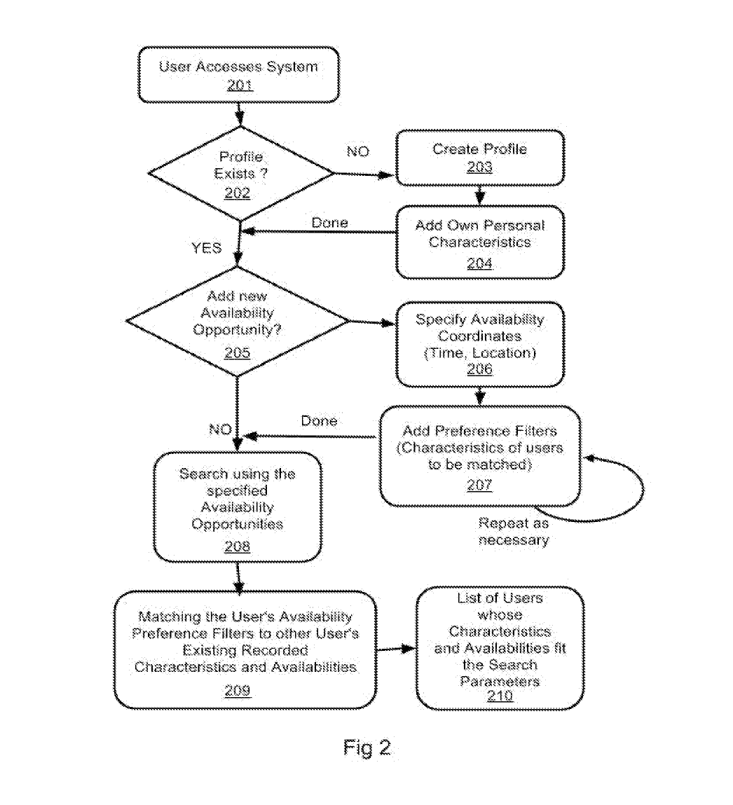

FIG. 2 describes the operation of one embodiment of the invention. The users will have to access the system using a plurality of methods; in the current embodiment, internet-based web access is the method to be used. Once the users gained access 201, using methods that are not specific to this invention, they will need a profile 201 of the type described in FIG. 1, entry 110. In the current embodiment the user will need to create their profile 203, which will contain some means of further communication with the user—email could be the preferred one in one embodiment, and then they will need to add their own personal characteristics 204, as those are necessary later for matching this user's requests against other user's filters. A user without a profile and characteristics is not going to have any match, and is therefore inexistent and useless from this invention's perspective.

Once the profile is created, the User will choose 205 to define a new set availability opportunities for which they are available to others. In that case, the user will define the coordinates 206, and then the set of filters 207 that will be used to filter out the visibility of the current availability opportunity. At this point, the user has registered their profile and availabilities, so they can respectively search other's availabilities and be matched on their own availabilities.

When the user chooses to actively search for other user's listed availabilities 208, the matching procedure 209 implemented in the processing engine 150 will access all the information stored in the storage 140, and will extract only the users 210 and their corresponding availabilities that have been unmasked by the user's query, its characteristics, and the preference filters set on those availability opportunities. It is expected that the user running the query will use means outside the scope of this invention to communicate with the users matched. The goal of the invention is to make use of the characteristics, preference filters, and matching mechanism to unmask availability only to those for whom it was intended in the first place.

Those skilled in the art will realize easily that there are numerous alternate embodiments that make use of this invention. The detailed description above presents only the most basic components that are necessary to build and use the system. In its simplest form, one embodiment of the invention can be used to expose the availability for vacation goers to meet people they “click with”. In the vacation-availability scenario, the user profiles will contain vacation coordinates and a full user-defined set of preferences for who they want to be available for. The profiles will be stored in an internet-accessible location and the user will have access to their profiles and to search and explore for matching opportunities through a graphical user interface such as, but not limited to, a web page accessible from web browsers, or a customized mobile application, or any other device that can display information from the internet. For vacation goers, the matching will be a simple boolean logic set of rules that identifies similar terms in the preference request set and the characteristics supplied, and additionally which identifies overlapping vacation periods and spatial coordinates. In the vacation going case embodiment, we will present the matching results in two separate ways, to allow us to differentiate between matching information that is free or charge, and matching information that we are going to charge for. The free information will be an aggregation that counts the number of matching users that falls into a specific class such as, but not limited to, same location, overlapping time interval, or same subset of preferences. The details identifying particular users and their contact information in the matched aggregate sets will be available for users in a special class, such as but not limited to paying users.

Another embodiment of the invention can be built around a more complex processing engine, in which the matching logic can be extended to include a value-based matching, and/or have multiple matchings and ranking of the results combined to keep the plurality of user profiles matched and sorted according to multiple criteria. One application of this embodiment could be a selective job market, where resumes and job descriptions are replaced by the preference filters used for matching, and where results are being kept in a ranked order, to allow employers and job seekers to be available permanently for their top choices. In this embodiment, the time and space coordinates of the availability for a job will most likely have a much lower influence (if any) compared to identifying and matching job and career related preferences. The employers will maintain a set of profiles that are associated with a specific or a type of jobs, and by the nature of the invention, the filters for those jobs are going to be hidden. This eliminates the classic “job description” centered approach to recruiting, and focuses on “working for company X” plus “skilled in Y,Z, expect opportunity A,B, and role C”. In this case the users will have a list of preferred companies they are monitoring, and a preferred set of roles, using a specific skill set. At all times, the job market will sort the best candidates for the best jobs, and for example, if a candidate specified a perpetual availability for company X, that implies that they will give up their current job to join company X as the right opportunity becomes available.

Both the vacation availability and the selective job market embodiments, and more generally any other future embodiment build on the idea of users volunteering their own personal information, will have to include additional components and/or methods that address the truthfulness of the information submitted in the user profiles. While those methods are not always necessary, and do not make the subject of this invention, they will be quite valuable to a large set of embodiments built using the current invention. Such truthfulness-verifying methods and components could include, but are not limited to, external user account and profile verification, questionnaires and tests to verify knowledge and skills, or even direct communication with the user.

Those skilled in the art will recognize that there are many alternate embodiments for the invention, and variations on implementations of the major components, the profiles with preference filters, the storage and the matching component of said profiles and their availabilities, and the presentation and use of the resulting matches are all covered by the current invention.

What is claimed is:

1. a method for defining, recording and making available for search, aggregation, and matching of a user's availability, as determined by a filter constructed from the user's own personal preferences and from other users' desired characteristics, traits or attributes, the method comprising of the steps of:
a. the user creating a profile comprising of:
i. a set of zero or more of his characteristics, traits or attributes on which the user wants to be matched on, and additionally comprising of
ii. a set of zero, or more availability opportunities, as described by a combination of
1. spatio-temporal coordinates and
2. of a set of zero, or more preference filters that list the characteristics, traits or attributes of other users that the current user is interested in and/or can become available for.
b. the user storing their profile into a common storage repository where his profile will be accessible for search and aggregation across all or a subset of the registered users.
c. when an operation such as but not limited to search, match, aggregation, etc is being initiated by a user and executed against the set of stored profiles, the processing engine will identify and extract the set of other users and their availabilities that have characteristics, traits, or attributes matching with the preference filters for the coordinates, characteristics, traits, or attributes of the initiating user.

2. a method of claim 1 wherein the coordinates of their availability can be missing in part or as a whole, specified either as undefined spatial availability or as perpetual temporal availability

3. a method of claim 1 wherein the set of preferences can have zero preferences, in which case everyone with an overlapping coordinate will be given access to that availability.

4. a method of claim 1 wherein the defining and recording of the user's availability is an automated process that extracts this information from other existing systems.

5. a method of claim 1 wherein the user's profile is being updated by an automated process, rather than by the user, for instance expiring availabilities, or suggested availabilities inferred from the existing and external sources of information.

6. a method of claim 1 wherein the operations performed on the user's availabilities and preferences go beyond searching, aggregation, matching, and the combination thereof, comprising of:
a. data segmentation, masking, and structural manipulation of the data.
b. applications of quantitative or numerical and ordering or ranking functions that extract derived information from the said availabilities.
c. approximations of the profile and filter entries for privacy-preserving and other purposes.
d. replications and mutations of the information above.

7. a method of claim 1 wherein the extraction and the presentation of the matching results can be done in full, partial or in various aggregated forms.

8. a method of claim 7 wherein the resulting information is being partially or fully obscured and released to the user initiating the matching operation only upon further interaction or conditions, such as but not limited to payment for the service.

9. a method of claim 1 wherein the users who have been involved in an interaction have the option to mutually assert the truthfulness and the quality of the characteristics information provided by the other party.

10. a system comprising of:
a. a storage component that records the user's characteristics, their availability coordinates and the associated preference filters and
b. a processing engine component that has access to and can process the data recorded by all the users.

11. the storage component of claim 10 wherein data is partitioned such that only a subset is accessible for the engine's operations, as determined by a policy, application context, or by some settings determined by the user who triggered the engine operation.

12. the processing engine component of claim 10 wherein the search, match, and aggregation operations can be choreographed in a workflow that is configurable either on a system-wide basis, or by the specifics of the user triggering the query, or directly specified by the user itself.

13. the processing engine component of claim 10 wherein the execution can take as an input various external sources of data in addition to the preferences and coordinates already stored.

14. the external sources of data of claim 13 wherein those sources are streaming continuously live data, and the output of the processing engine component will generate accordingly streaming, live output data.

15. the processing engine component of claim 10 wherein the components of the matching workflow can be executed in parallel by multiple instances of the processing engine.

16. a method of claim 15 wherein the results from the parallel processing components will be combined to produce a final result.
